(19) United States
(12) Patent Application Publication
(10) Pub. No.: US 2009/0281899 A1
(43) Pub. Date: Nov. 12, 2009

(54) METHOD FOR PLACING ADVERTISEMENT ON WEB PAGES

(76) Inventor: Peigen Jiang, Sammamish, WA (US)

Correspondence Address: PEIGEN JIANG, 19480 SE 28TH PLACE, SAMMAMISH, WA, 98075, US

(21) Appl. No.: 12/116,938

(22) Filed: May 7, 2008

(51) Int. Cl. G06Q 30/00

(52) U.S. Cl. 705/14.55; 705/14.69; 705/14.73; 705/35; 705/14.71

(57) ABSTRACT

A method for placing advertisements on a web page is disclosed which comprises providing a web page having a designated space for advertisement, providing a clickable member on the web page with a link to a procurement process, once the clickable member being clicked, the procurement process is invoked, uploading an advertisement upon a completion of the procurement process, placing the uploaded advertisement solely on the designated space of the web page, and displaying the web page with the uploaded advertisement when the web page is requested.

### BACKGROUND

The present invention relates generally to advertisement placement, and, more particularly, to placing advertisements on web pages over the Internet.

Advertisements are traditionally distributed over published materials, such as magazines and newspapers, or over broadcasting media, such as radio or television. A problem with the traditional advertisement distribution method is that the advertised materials are often being ignored and even regarded as nuisances, because people who receive those published or broadcasted materials are not intend to receive those advertised materials.

The Internet provides another venue to distribute advertisements through keyword search and placing banners on web pages, etc. However, advertisement placement of Internet related venues are still generally handled by advertisement agencies or their equivalents as in traditional venues. The advertisement agencies serve as brokers between advertisers and website owners. Adding a middle layer certainly increase advertisement cost for the advertisers. Besides, the middle layer also hinders advertiser's control of the advertisement placement. Using an online newspaper advertisement as an example, an advertiser can generally make decisions on where, when and for how long their advertisement appears on the online newspaper. But how well the content of the online newspaper is relevant to the advertisement is often beyond pre-determination due to a very fluid nature of the newspaper content.

As such, what is desired is method to allow advertisers to directly place their advertisements on a web site and such direct placement can be realized immediately.

### SUMMARY

The present invention discloses a method for placing advertisements on a web page which comprises providing a web page having a designated space for advertisement, providing a clickable member on the web page with a link to a procurement process, once the clickable member being clicked, the procurement process is invoked, uploading an advertisement upon a completion of the procurement process, placing the uploaded advertisement solely on the designated space of the web page, and displaying the web page with the uploaded advertisement when the web page is requested.

The construction and method of operation of the invention, however, together with additional objects and advantages thereof, will be best understood from the following description of specific embodiments when read in connection with the accompanying drawings.

### BRIEF DESCRIPTION OF THE DRAWING

FIG. 1 illustrates a web page with areas for placing advertisement.

FIG. 2 illustrates one of the advertising spaces of FIG. 1 available for rent.

FIG. 3 illustrates an advertising-space rental process according to one embodiment of the present invention.

FIG. 4 illustrates an implementation of the payment process of FIG. 3.

FIG. 5 is a block diagram illustrating an embodiment system of the present invention.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### Description

The following will provide a detailed description of a method and system to allow web advertisers to directly determine the placement of their advertisements and such determinations can be instantly reflected on the designated web pages.

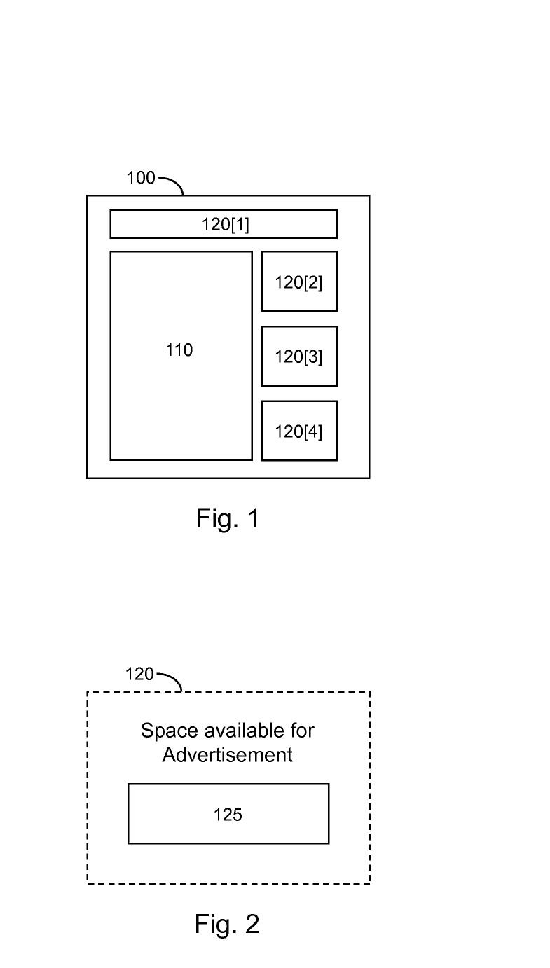

FIG. 1 illustrates a typical web page 100 with various areas for showing contents as well as advertisements. The typical web page 100 has a designated content area 110 that can be used to present news or other materials. As an example, the typical web page 100 has a designated banner area 120[1] for placing a banner advertisement, and other areas 120[2:4] for placing other display advertisements.

FIG. 2 illustrates one of the advertising spaces 120[1:4] of FIG. 1 available for rent. The for-rent advertising space 120 displaces a for-rent message, such as “space available for advertisement”. The for-rent advertising space 120 has a clickable member equivalent of a selection button 125, once being clicked, a payment and an uploading process will be invoked.

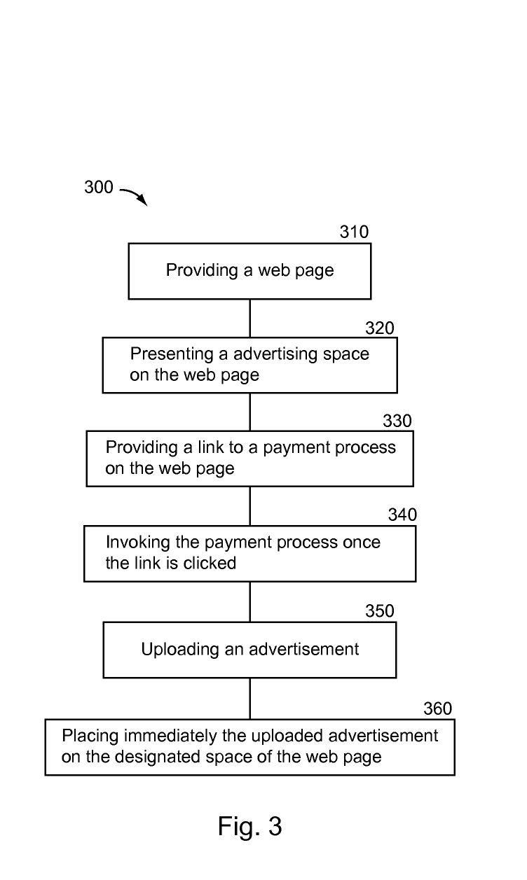

FIG. 3 illustrates an advertising-space rental process 300 according to one embodiment of the present invention. The process 300 begins with step 310, where a web page with attractive content is provided. Beside the attractive content, the web page also presents one or more designated advertising space for advertisers to rent as shown in step 320. The advertising space can be rented for any length of time, weeks, days or even hours. Somewhere on the web page, ideally within the designated advertising space, a selection button is provided with a link to a payment process as shown in step 330. Once the selection button is clicked by an advertiser in step 340, the payment process will be invoked. Similar to any other online purchasing process, the present payment process may include entering credit card information by the advertiser and verifying the credit card information by a credit card company, etc. Once the payment process is complete, the web site will allow the advertiser to upload his or her advertising material in step 350. Such advertising material may be a graphic file containing advertisement copy as well as artworks. The web site may provide tools for the advertiser to layout his or her advertising materials. The web site owner may also want to perform a screening on the uploaded advertising materials for any inappropriate content. Such screening can be carried out entirely by software. Once the advertising material is fully uploaded, the designated web page places the advertisement immediately on the designated space in step 360. Therefore, when the web page is requested next time the uploaded advertisement can be displayed on the web page. Immediately placing the advertisement is a preferred implementation, as in this way the advertisement is most freshly related to the web page content. However, a skilled in the art would realize that the placing can be delayed for a predetermined amount of time as long as the arrangement makes sense for both the web site owner and the advertiser. In this case, the web site owner may still require the advertiser to pay for the delayed or idle time. A skilled in the art may also realize that the designated space can be adjusted upon placing the uploaded advertisement for a better fit. Apparently, an advantage of the present invention is to allow advertisers to determine the best venues to place their advertisements. For instance, when an LCD TV set vender sees an online news article about phasing out analogue TV broadcasting, the vender may immediately purchase and display a TV set advertisement on the web page alongside the news article. The present invention not only helps advertisers, but also helps website owners to sell more advertising space by improving advertising placement efficiency. The advertisement is displayed solely on the designated web page and the designated space thereof, unless specified otherwise by the advertiser. For instance, the advertiser may request the advertisement be displayed on related web pages. But such options will have to be predefined by the web site.

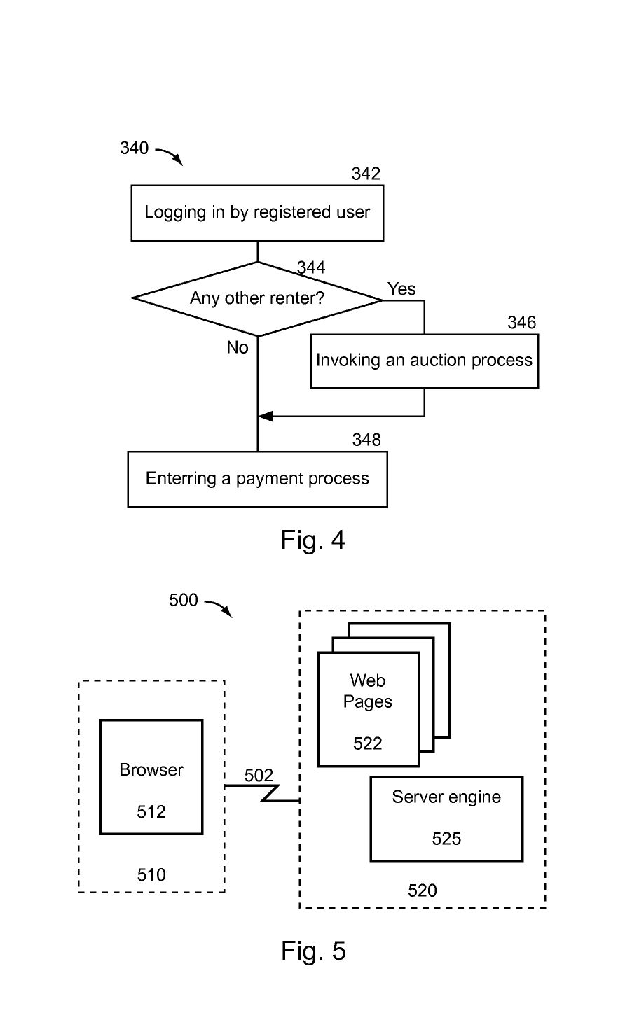

FIG. 4 illustrates an implementation of the payment process 340 of FIG. 3. The payment process 340 may begin with an optional logging process by a registered user in step 342. An advertiser may pre-register with the web site and provide the web site will relevant information once. The advertiser can simply log in the web site thereafter without going through the information enter process again. Then the web site performs a check to see if there is any other renter for the same advertising space in step 344. If there is at least another renter seeking for the same advertising space, an auction process will be invoked in step 346. A winner will then entering a payment process in step 348. When there are no competing interests for the same advertising space, the advertiser will enter the payment process directly. As aforementioned the payment process may involve credit card or other online payment systems.

FIG. 5 is a block diagram illustrating an embodiment system 500 of the present invention. The system 500 includes a client system 510 and a server system 520 communicating with each other over the Internet 502. The client system 510 has a browser 512 for receiving and display web pages. The server system 520 has a server engine 525 and various web pages 522. The server engine 525 receives HTTP requests from the client system 510 to access web pages 522 identified by URLs and provides the web pages 522 to the client system 510. The web pages 522 may have contents as well as reserved advertising space. A HTTP request may indicate that an advertiser has clicked on a selection button to start an advertising-space rental process. Then the server engine 525 will act upon the HTTP request, and provide appropriate web pages, such as payment processing or uploading process, etc., to the client system 510. Once the advertising material is uploaded to the server system 520, the server engine 525 will place the advertising material in the designated advertising space of the designated web page 522. Next time when the same web page 522 is requested by a client system, that web page 522 with the advertising material will be provided by the server engine 525 to the client system. In such a way, the advertiser can choose a particular web page to display his or her display advertisement.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for placing advertisements on a web page, the method comprising:
providing a web page having a designated space for advertisement;
providing a clickable member on the web page with a link to a procurement process, once the clickable member being clicked, the procurement process will be invoked;
uploading an advertisement upon a completion of the procurement process; and
placing the uploaded advertisement solely on the designated space of the web page.

2. The method of claim 1, wherein the advertisement is a display advertisement.

3. The method of claim 1, wherein the procurement process includes processing credit card information.

4. The method of claim 1, wherein the procurement process includes an auction process when there are two or more advertisers seeking the same designated space.

5. The method of claim 1, wherein the placing the uploaded advertisement occurs at a predetermined time.

6. The method of claim 5, wherein the predetermined time is immediately following the completion of the uploading.

7. The method of claim 1 further comprising displaying the web page with the uploaded advertisement when the web page is requested.

8. The method of claim 1, wherein the clickable member is a selection button.

9. The method of claim 1, wherein the designated space is adjusted during the placement of the uploaded advertisement.

10. A method for placing advertisements on a web page, the method comprising:
providing a web page having a designated space for advertisement;
providing a clickable member on the web page with a link to a procurement process, once the clickable member being clicked, the procurement process will be invoked;
uploading an advertisement upon a completion of the procurement process; and
placing the uploaded advertisement solely on the designated space of the web page immediately after the completion of the uploading.

11. The method of claim 10, wherein the advertisement is a display advertisement.

12. The method of claim 10, wherein the procurement process includes processing credit card information.

13. The method of claim 10, wherein the procurement process includes an auction process when there are two or more advertisers seeking the same designated space.

14. The method of claim 10 further comprising displaying the web page with the uploaded advertisement when the web page is requested.

15. The method of claim 10, wherein the clickable member is a selection button.

16. The method of claim 10, wherein the designated space is adjusted during the placement of the uploaded advertisement.

17. A method for placing advertisements on a web page, the method comprising:
providing a web page having a designated space for advertisement;
providing a clickable member on the web page with a link to a procurement process, once the clickable member being clicked, the procurement process will be invoked;
uploading an advertisement upon a completion of the procurement process;
placing the uploaded advertisement solely on the designated space of the web page; and
displaying the web page with the uploaded advertisement when the web page is requested.

18. The method of claim 17, wherein the procurement process includes processing credit card information.

19. The method of claim 17, wherein the procurement process includes an auction process when there are two or more advertisers seeking the same designated space.

20. The method of claim 17, wherein the designated space is adjusted during the placement of the uploaded advertisement.
